(19) United States
(12) Patent Application Publication
(10) Pub. No.: US 2007/0078207 A1
(43) Pub. Date: Apr. 5, 2007

(54) Stabilizer cyanoacrylate formulations

(76) Inventors: Jerry Y. Jonn, Raleigh, NC (US); Julian Quintero, Raleigh, NC (US)

Correspondence Address: HUTCHISON LAW GROUP PLLC, PO BOX 31686, RALEIGH, NC, 27612, US

(21) Appl. No.: 11/240,277

(22) Filed: Sep. 30, 2005

(51) Int. Cl. C08F 2/42

(52) U.S. Cl. 524/347; 524/556

(57) ABSTRACT

A stabilized adhesive composition is provided including one or more polymerizable cyanoacrylate monomers, a first free radical stabilizer in a stabilization effective amount, and a second free radical stabilizer in a stabilization effective amount. The free radical stabilizers are selected to minimize mutagenicity in the composition and are used in amounts which provide adequate stabilization for long term storage while reducing disadvantageous effects of the free radical stabilizers. The stabilized adhesive composition further may include a first anionic stabilizer comprising a vapor phase anionic stabilizer and a second anionic stabilizer comprising a liquid phase anionic stabilizer. The stabilized adhesive composition may also include or be used with a polymerization initiator. Methods for the application of the stabilized adhesive compositions to living tissue are also provided.

### BACKGROUND

1. Field

The invention relates to stabilized monomer and polymer adhesive and sealant compositions, and to their use for industrial and medical applications.

2. State of the Art

Monomer and polymer adhesives are used in both industrial (including household) and medical applications. Included among these adhesives are the 1,1-disubstituted ethylene monomers and polymers, such as the α-cyanoacrylates. Since the discovery of the adhesive properties of such monomers and polymers, they have found wide use due to the speed with which they cure, the strength of the resulting bond formed, and their relative ease of use. These characteristics have made α-cyanoacrylate adhesives the primary choice for numerous applications such as bonding plastics, rubbers, glass, metals, wood, and, more recently, biological tissues.

Medical applications of 1,1-disubstituted ethylene adhesive compositions include use as an alternate or an adjunct to surgical sutures and staples in wound closure as well as for covering and protecting surface wounds such as lacerations, abrasions, burns, stomatitis, sores, and other surface wounds. When an adhesive is applied, it is usually applied in its monomeric form, and the resultant polymerization gives rise to the desired adhesive bond.

For example, polymerizable 1,1-disubstituted ethylene monomers, and adhesive compositions comprising such monomers, are disclosed in U.S. Pat. No. 5,328,687 to Leung et al. Suitable methods for applying such compositions to substrates, and particularly in medical applications, are described in, for example, U.S. Pat. Nos. 5,928,611; 5,582,834; 5,575,997; and 5,624,669, all to Leung et al.

Some monomeric α-cyanoacrylates are extremely reactive, polymerizing rapidly in the presence of even minute amounts of an initiator, including moisture present in the air or on moist surfaces such as animal tissue. Monomers of α-cyanoacrylates are anionically polymerizable or free radical polymerizable, or polymerizable by zwitterions or ion pairs to form polymers. Once polymerization has been initiated, the cure rate can be very rapid, depending on the choice of monomer. Therefore, in order to obtain a monomeric α-cyanoacrylate composition with a suitable shelf-life, polymerization inhibitors such as anionic and free radical stabilizers are often added to the compositions. However, addition of certain stabilizers may result in substantial retardation of the cure rate of the composition. Moreover, some commonly used stabilizers are known to be toxic, mutagenic or carcinogenic, depending on the composition and/or amount used.

Thus, a need exists for improved cyanoacrylate monomer adhesive compositions having an acceptable shelf life without sacrificing the performance of the adhesive including its biocompatibility. Further, a need exists to obtain satisfactory stabilization of cyanoacrylate compositions used in contact with animals, including humans, with reduced, minimal or no adverse effect.

### SUMMARY

A stabilized adhesive composition is provided comprising one or more polymerizable cyanoacrylate monomers, a first free radical stabilizer consisting of hydroquinone in an amount of 5 to 70 ppm and a second free radical stabilizer consisting of butylated hydroxyanisole in an amount of 500 to 10,000 ppm.

In another embodiment, a stabilized adhesive composition is provided comprising one or more polymerizable cyanoacrylate monomers, a first free radical stabilizer consisting of hydroquinone in a stabilization effective amount, a second free radical stabilizer consisting of butylated hydroxyanisole in a stabilization effective amount, a first anionic stabilizer comprising a vapor phase anionic stabilizer, and a second anionic stabilizer comprising a liquid phase anionic stabilizer, wherein the stabilized adhesive composition exhibits a viscosity less than about 200 cp over a period of at least one year and exhibits a mutagenicity activity level less than a minimum criteria of mutant frequency of 124.1×10E-6 units in a mouse lymphoma screening test. In one embodiment, the stabilized adhesive composition exhibits an increase in viscosity of less than 500% over a period of at least one year, preferably over a period of at least two years.

In a further embodiment, a stabilized adhesive composition is provided comprising one or more polymerizable cyanoacrylate monomers, a first free radical stabilizer consisting of hydroquinone in a stabilization effective amount and a second free radical stabilizer consisting of butylated hydroxyanisole in a stabilization effective amount, wherein the ratio of the stabilization effective amount of hydroquinone to the stabilization effective amount of butylated hydroxyanisole is 1:25 to 1:75.

In another embodiment, a method of treating living tissue is provided, comprising applying to living tissue a biocompatible adhesive composition comprising: one or more polymerizable cyanoacrylate monomers, a first free radical stabilizer consisting of hydroquinone in a stabilization effective amount, a second free radical stabilizer consisting of butylated hydroxyanisole in a stabilization effective amount, a first anionic stabilizer comprising a vapor phase anionic stabilizer, and a second anionic stabilizer comprising a liquid phase anionic stabilizer, wherein the ratio of the stabilization effective amount of hydroquinone to the stabilization effective amount of butylated hydroxyanisole is 1:25 to 1:75.

### BRIEF DESCRIPTION OF THE DRAWINGS

FIG. 1 is a graphical representation of the viscosity (cP) versus the time in days of the comparative cyanoacrylate formulation labeled Formulation A in Table 2, and discussed in Example 2.

FIG. 2 is a graphical representation of the viscosity (cP) versus the time in days of the cyanoacrylate formulation labeled Formulation B in Table 2, and discussed in Example 2.

### DETAILED DESCRIPTION OF THE PREFERRED EMBODIMENTS

A stabilized cyanoacrylate adhesive composition comprising one or more cyanoacrylate monomers and a method of using such an adhesive composition is provided. The stabilized cyanoacrylate adhesive composition is achieved through the use of a combination of particular free radical stabilizers, preferably the use of a combination of particular free radical stabilizers in defined amounts.

A stable cyanoacrylate adhesive composition comprising one or more cyanoacrylate monomers is prepared by adding a combination of free radical stabilizers in amounts which reduce or eliminate mutagenic or other harmful effects, while providing acceptable stabilization of the monomeric cyanoacrylate adhesive composition. The stable monomeric cyanoacrylate adhesive composition may be used safely in medical applications involving contact with living patients, including human patients. Moreover, the combination of stabilizers inhibits polymerization of the monomers of the composition sufficiently to enable an acceptable shelf life for the stable monomeric cyanoacrylate adhesive composition. The stable monomeric cyanoacrylate adhesive compositions are preferably sterilized for use in medical applications. More preferably, the stable monomeric cyanoacrylate adhesive compositions may be sterilized by dry heat sterilization while retaining suitability for medical applications.

Suitable free radical stabilizing agents for use in cyanoacrylate adhesive compositions comprising one or more cyanoacrylate monomers include hydroquinone, hydroquinone monomethyl ether, catechol, pyrogallol, benzoquinone, 2-hydroxybenzoquinone, p-methoxy phenol, t-butyl catechol, butylated hydroxy anisole, butylated hydroxy toluene, and t-butyl hydroquinone and mixtures or combinations thereof. In preferred embodiments, a combination of at least two free radical stabilizing agents is used. Preferably, in these embodiments, the free radical stabilizing agents used are at least hydroquinone and butylated hydroxy anisole (BHA). In an even more preferred embodiment, three free radical stabilizing agents are used, preferably hydroquinone, BHA and p-methoxy phenol.

The free radical stabilizing agent or combination of free radical stabilizing agents, such as hydroquinone in combination with one or more additional free radical stabilizing agents, is used in the cyanoacrylate adhesive compositions comprising one or more cyanoacrylate monomers in a stabilization effective amount. For purposes herein, a “stabilization effective amount” is an amount sufficient to provide at least partial stabilization of the polymerization monomer.

“Stabilization” or “stabilized” as used herein may be measured by the viscosity of the cyanoacrylate adhesive composition comprising one or more cyanoacrylate monomers over a period of time since an indication of premature polymerization in cyanoacrylate monomer compositions is an increase in viscosity of the composition over time. That is, as the adhesive composition comprising one or more cyanoacrylate monomers polymerizes, the viscosity of the composition increases. If the viscosity becomes too high, i.e., too much premature polymerization has occurred, the composition becomes unsuitable for its intended use or becomes very difficult to apply. Thus, while some polymerization or thickening of the composition may occur, such as can be measured by changes in viscosity of the composition, such change, when the cyanoacrylate monomer composition is stabilized, is not so extensive as to destroy or significantly impair the usefulness of the compositions. By providing a certain combination of free radical stabilizers, including hydroquinone in a stabilization effective amount, the cyanoacrylate adhesive composition comprising one or more cyanoacrylate monomers will exhibit less or an acceptably low amount of premature polymerization compared to cyanoacrylate compositions comprising one or more cyanoacrylate monomers without such a stabilizing combination. Such a stabilized composition allows control over the viscosity of the composition. Preferably, the combination of free radical stabilizers in stabilization effective amounts will provide sufficient inhibition of polymerization of the monomer, i.e., stabilization of the compositions, that the monomeric cyanoacrylate adhesive compositions show an increase in viscosity of less than 500%, preferably less than 300%, more preferably less than 200%, and most preferably less than 150%, as a result of premature polymerization or thickening over a period of at least one year, preferably 18 months, most preferably at least two years. In a more particular embodiment, the cyanoacrylate monomer composition including the combination of free radical stabilizers in stabilization effective amounts will be stabilized, or show an increase in viscosity of less than 100% for a time period of at least six months, preferably for at least a year.

Generally, the viscosity of the cyanoacrylate monomer composition including the combination of free radical stabilizers will be less than about 200 centipoise (cP) over a period of at least one year, preferably less than at least two years, and preferably less than about 100 cP over a period of at least one year. One of skill in the art may readily determine the viscosity of the cyanoacrylate monomer adhesive composition and further determine the desired viscosity for suitability for the desired end use. In preferred embodiments, the stabilization effective amounts of the free radical stabilizers are the amounts detailed herein.

Hydroquinone typically is used in the combination of free radical stabilizers in a stabilization effective amount, preferably, an amount of 5 to 70 ppm, preferably 10 to 70 ppm. In more preferred embodiments, hydroquinone is used in an amount of 15 to 60 ppm. In the most preferred embodiments, hydroquinone is used in an amount of 20 to 50 ppm.

The polymerizable cyanoacrylate compositions comprising one or more cyanoacrylate monomers include a combination or mixture of free radical stabilizing agents including hydroquinone and at least one additional free radical stabilizing agent. The at least one additional free radical stabilizing agent may be any of the agents known for use with cyanoacrylate monomers. Preferably, the mixture of free radical stabilizing agents includes hydroquinone and one of butylated hydroxy anisole or p-methoxyphenol. In the some embodiments, the mixture of free radical stabilizing agents includes hydroquinone, BHA and p-methoxy phenol. In certain preferred embodiments of the cyanoacrylate adhesive composition comprising one or more cyanoacrylate monomers, the only free radical stabilizers present in the composition are hydroquinone, BHA and p-methoxy phenol, e.g., no other free radical stabilizers are in the cyanoacrylate monomer composition.

It has now been found that hydroquinone may be used in sufficiently low amounts to avoid or reduce any harmful effects resulting from the presence of hydroquinone in a cyanoacrylate adhesive composition comprising one or more cyanoacrylate monomers upon use of the polymerizable cyanoacrylate adhesive composition when the hydroquinone is used in combination with at least one additional free radical stabilizer, preferably, BHA.

The stabilization effective amount of hydroquinone, when hydroquinone is one of the free radical stabilizers used in the cyanoacrylate adhesive composition comprising one or more cyanoacrylate monomers, preferably is an amount which does not exhibit unacceptable mutagenic effects when used in the cyanoacrylate composition.

BHA, when used in combination with hydroquinone in polymerizable cyanoacrylate adhesive compositions comprising one or more cyanoacrylate monomers, is used in stabilization effective amounts known to be useful for stabilizing polymerizable cyanoacrylate adhesive compositions, depending on the end use of the composition. In order to minimize any toxic or mutagenic effect from the cyanoacrylate adhesive composition upon use, the BHA typically is used in an amount much greater than the amount of hydroquinone, preferably 25 to 75 times as much BHA as hydroquinone, e.g., in a ratio of hydroquinone to BHA of 1:25 to 1:75. In a preferred embodiment, the ratio of hydroquinone to BHA is 1:30 to 1:50. In preferred embodiments, BHA is used in combination with hydroquinone in amounts of 500 to 10,000, preferably 800 to 3200 ppm, more preferably 1000 to 2000 ppm.

If a third or additional stabilizers are used, such stabilizer is generally considered a secondary stabilizer. Typically the amount of such stabilizers will be less than the amount of BHA; however, the amount may be determined by the particular stabilizer used and the purpose for which the adhesive is to be utilized. In one embodiment, a third stabilizer, or secondary stabilizer, p-methoxy phenol, is employed with hydroquinone and BHA. The p-methoxy phenol may be used in stabilization effective amounts known to be useful for stabilizing polymerizable cyanoacrylate adhesive compositions, depending on the end use of the composition. In preferred embodiments, p-methoxy phenol may be used in amounts of 0 to 500 ppm, preferably 50-200 ppm.

In certain embodiments, the cyanoacrylate adhesive compositions include one or more cyanoacrylate monomers, at least two free radical stabilizing agents and one or more suitable anionic stabilizing agents. The cyanoacrylate adhesive compositions may optionally include both at least one anionic vapor phase stabilizer and at least one anionic liquid phase stabilizer. These stabilizing agents inhibit polymerization. Examples of such anionic agents are described for example, in U.S. Pat. No. 6,620,846, incorporated herein by reference in its entirety.

The anionic vapor phase stabilizers may be selected from among known stabilizers, including, but not limited to, sulfur dioxide, boron trifluoride, and hydrogen fluoride. The amount of anionic vapor phase stabilizer that is added to the monomer composition depends on the identity of the liquid phase stabilizer(s) chosen in combination with it, the monomer to be stabilized, as well as the packaging material to be used for the composition. Preferably, each anionic vapor phase stabilizer is added to give a concentration of less than 200 parts per million (ppm). In preferred embodiments, each anionic vapor phase stabilizer is present from about 1 to 200 ppm, more preferably from about 10 to 75 ppm, even more preferably from about 10 to 50 ppm, and most preferably from 10 to 20 ppm. The amount to be used can be determined by one of ordinary skill in the art using known techniques without undue experimentation.

In embodiments, the anionic stabilizer comprises, among other things, a vapor phase anionic stabilizer that is sulfur dioxide.

In embodiments, the liquid phase anionic stabilizer is a very strong acid. As used herein, a very strong acid is an acid that has an aqueous pKₐ of less than 1.0. Suitable very strong acidic stabilizing agents include, but are not limited to, very strong mineral and/or oxygenated acids. Examples of such very strong acids include, but are not limited to, sulfuric acid (pKₐ-3.0), perchloric acid (pKₐ-5), hydrochloric acid (pKₐ-7.0), hydrobromic acid (pKₐ-9), fluorosulfonic acid (pKₐ<-10), chlorosulfonic acid (pKₐ-10). In embodiments, the very strong acid liquid phase anionic stabilizer is added to give a final concentration of 1 to 200 ppm. Preferably, the very strong acid liquid phase anionic stabilizer is present in a concentration of from about 5 to 80 ppm, more preferably 10 to 40 ppm. The amount of very strong acid liquid phase anionic stabilizer to be used can be determined by one of ordinary skill in the art without undue experimentation.

Preferably, the very strong acid liquid phase anionic stabilizer is sulfuric acid, perchloric acid, or chlorosulfonic acid. More preferably, the very strong acid liquid phase anionic stabilizer is sulfuric acid.

In embodiments, sulfur dioxide is used as a vapor phase anionic stabilizer and sulfuric acid is used as a liquid phase anionic stabilizer.

The composition may also optionally include at least one other anionic stabilizing agent that inhibits polymerization. These agents are herein referred to as secondary anionic active agents to contrast them with the strong or very strong liquid phase anionic stabilizers, which are referred to hereinbelow as “primary” anionic stabilizers. The secondary anionic active agents can be included in the compositions to adjust the cure speed of the adhesive composition, for example.

The secondary anionic active agent would normally be an acid with a higher pKₐ than the primary anionic stabilizing agent and may be provided to more precisely control the cure speed and stability of the adhesive, as well as the molecular weight of the cured adhesive. Any mixture of primary anionic stabilizers and secondary active agents may be included as long as the chemistry of the composition is not compromised and the mixture does not significantly inhibit the desired polymerization rate of the composition. Furthermore, the mixture should not, in medical adhesive compositions, show unacceptable levels of toxicity.

Suitable secondary anionic active agents include those having aqueous pKₐ ionization constants ranging from 2 to 8, preferably from 2 to 6, and most preferably from 2 to 5. Examples of such suitable secondary anionic stabilizing agents include, but are not limited to, organic acids, such as acetic acid (pKₐ 4.8), benzoic acid (pKₐ 4.2), chloroacetic acid (pKₐ 2.9), cyanoacetic acid, and mixtures thereof. Preferably these secondary anionic stabilizing agents are organic acids, such as acetic acid or benzoic acid. In embodiments, the amount of acetic acid and/or benzoic acid is about 25-500 ppm. The concentration of acetic acid is typically 50-400 ppm, preferably 75-300 ppm, and more preferably 100-200 ppm.

Combinations of at least one vapor phase stabilizer and at least one liquid phase anionic stabilizer are preferred. For example, combinations of sulfur dioxide and sulfuric acid may be used. The two types of anionic stabilizers are chosen in conjunction such that the stabilizers are compatible with the chosen adhesive composition and each other stabilizer, as well as with the packaging material and the equipment used to make and package the composition. In other words, the combination of vapor phase stabilizer(s), liquid phase stabilizer(s), and monomer should be such that a stabilized, substantially unpolymerized adhesive composition is present after packaging (and sterilization, where the composition is intended for medical applications).

Preferred cyanoacrylate adhesive monomer compositions including the stabilizers as described, and polymers formed therefrom, are useful as tissue adhesives, sealants for preventing bleeding or for covering open wounds, and in other biomedical applications. The monomer compositions find uses in, for example, preventing body fluid leakage, sealing air leakage in the body, tissue approximation, apposing surgically incised or traumatically lacerated tissues; retarding blood flow from wounds; drug delivery; dressing burns; dressing skin or other superficial or deep tissue surface wounds (such as abrasions, chaffed or raw skin, and/or stomatitis); and aiding repair and regrowth of living tissue. Monomer compositions of the present invention, and polymers formed therefrom, have broad application for sealing wounds in various living tissue, internal organs and blood vessels, and can be applied, for example, on the interior or exterior of blood vessels and various organs or tissues. Monomer compositions of the present invention, and polymers formed therefrom, are also useful in industrial and home applications, for example in bonding rubbers, plastics, wood, composites, fabrics, and other natural and synthetic materials.

Monomers that may be used in this invention are readily polymerizable, e.g. anionically polymerizable or free radical polymerizable, or polymerizable by zwitterions or ion pairs to form polymers. Some such monomers are disclosed in, for example, U.S. Pat. No. 5,328,687 to Leung, et al., which is hereby incorporated in its entirety by reference herein. Preferably, the cyanoacrylate adhesive compositions comprise one or more cyanoacrylate monomers and are biocompatible. The cyanoacrylate adhesive compositions comprising one or more cyanoacrylate monomers may include combinations or mixtures of cyanoacrylate monomers.

The term “biocompatible” refers to a material being suited for and meeting the requirements of a medical device, used for either long or short term implants or for non-implantable applications, such that when implanted or applied in an intended location, the material serves the intended function for the required amount of time without causing an unacceptable response. Long term implants are defined as items implanted for more than 30 days.

By way of example, useful monomers include α-cyanoacrylates of formula (I). These monomers are known in the art and have the formula 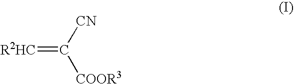
wherein R² is hydrogen and R³ is a hydrocarbyl or substituted hydrocarbyl group; a group having the formula —R⁴—O—R⁵—O—R⁶, wherein R⁴ is a 1,2-alkylene group having 2-4 carbon atoms, R⁵ is an alkylene group having 2-4 carbon atoms, and R⁶ is an alkyl group having 1-6 carbon atoms; or a group having the formula 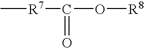
wherein R⁷ is 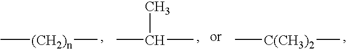
wherein n is 1-10, preferably 1-5 carbon atoms and R⁸ is an organic moiety.

Examples of suitable hydrocarbyl and substituted hydrocarbyl groups include straight chain or branched chain alkyl groups having 1-16 carbon atoms; straight chain or branched chain C₁-C₁₆ alkyl groups substituted with an acyloxy group, a haloalkyl group, an alkoxy group, a halogen atom, a cyano group, or a haloalkyl group; straight chain or branched chain alkenyl groups having 2 to 16 carbon atoms; straight chain or branched chain alkynyl groups having 2 to 12 carbon atoms; cycloalkyl groups; aralkyl groups; alkylaryl groups; and aryl groups.

The organic moiety R⁸ may be substituted or unsubstituted and may be straight chain, branched or cyclic, saturated, unsaturated or aromatic. Examples of such organic moieties include C₁-C₈ alkyl moieties, C₂-C₈ alkenyl moieties, C₂-C₈ alkynyl moieties, C₃-C₁₂ cycloaliphatic moieties, aryl moieties such as phenyl and substituted phenyl and aralkyl moieties such as benzyl, methylbenzyl, and phenylethyl. Other organic moieties include substituted hydrocarbon moieties, such as halo (e.g., chloro-, fluoro- and bromo-substituted hydrocarbons) and oxy-substituted hydrocarbon (e.g., alkoxy substituted hydrocarbons) moieties. Preferred organic radicals are alkyl, alkenyl, and alkynyl moieties having from 1 to about 8 carbon atoms, and halo-substituted derivatives thereof. Particularly preferred are alkyl moieties of 4 to 6 carbon atoms.

In the cyanoacrylate monomer of formula (I), R³ is preferably an alkyl group having 1-10 carbon atoms or a group having the formula -AOR⁹, wherein A is a divalent straight or branched chain alkylene or oxyalkylene moiety having 2-8 carbon atoms, and R⁹ is a straight or branched alkyl moiety having 1-8 carbon atoms.

Examples of groups represented by the formula -AOR⁹ include 1-methoxy-2-propyl, 2-butoxy ethyl, isopropoxy ethyl, 2-methoxy ethyl, and 2-ethoxy ethyl.

The α-cyanoacrylates of formula (i) can be prepared according to methods known in the art. U.S. Pat. Nos. 2,721,858 and 3,254,111, each of which is hereby incorporated in its entirety by reference, disclose methods for preparing α-cyanoacrylates. For example, the α-cyanoacrylates can be prepared by reacting an alkyl cyanoacetate with formaldehyde in a nonaqueous organic solvent and in the presence of a basic catalyst, followed by pyrolysis of the anhydrous intermediate polymer in the presence of a polymerization inhibitor.

The α-cyanoacrylates of formula (I) wherein R³ is a group having the formula R⁴—O—R⁵—O—R⁶ can be prepared according to the method disclosed in U.S. Pat. No. 4,364,876 to Kimura et al., which is hereby incorporated in its entirety by reference. In the Kimura et al. method, the α-cyanoacrylates are prepared by producing a cyanoacetate by esterifying cyanoacetic acid with an alcohol or by transesterifying an alkyl cyanoacetate and an alcohol; condensing the cyanoacetate and formaldehyde or para-formaldehyde in the presence of a catalyst at a molar ratio of 0.5-1.5:1, preferably 0.8-1.2:1, to obtain a condensate; depolymerizing the condensation reaction mixture either directly or after removal of the condensation catalyst to yield crude cyanoacrylate; and distilling the crude cyanoacrylate to form a high purity cyanoacrylate.

The α-cyanoacrylates of formula (I) wherein R³ is a group having the formula 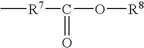
can be prepared according to the procedure described in U.S. Pat. No. 3,995,641 to Kronenthal et al., which is hereby incorporated in its entirety by reference. In the Kronenthal et al. method, such α-cyanoacrylate monomers are prepared by reacting an alkyl ester of an α-cyanoacrylic acid with a cyclic 1,3-diene to form a Diels-Alder adduct which is then subjected to alkaline hydrolysis followed by acidification to form the corresponding α-cyanoacrylic acid adduct. The α-cyanoacrylic acid adduct is preferably esterified by an alkyl bromoacetate to yield the corresponding carbalkoxymethyl α-cyanoacrylate adduct. Alternatively, the α-cyanoacrylic acid adduct may be converted to the α-cyanoacrylyl halide adduct by reaction with thionyl chloride. The α-cyanoacrylyl halide adduct is then reacted with an alkyl hydroxyacetate or a methyl substituted alkyl hydroxyacetate to yield the corresponding carbalkoxymethyl α-cyanoacrylate adduct or carbalkoxy alkyl α-cyanoacrylate adduct, respectively. The cyclic 1,3-diene blocking group is finally removed and the carbalkoxy methyl α-cyanoacrylate adduct or the carbalkoxy alkyl α-cyanoacrylate adduct is converted into the corresponding carbalkoxy alkyl α-cyanoacrylate by heating the adduct in the presence of a slight deficit of maleic anhydride.

Examples of monomers of formula (I) include cyanopentadienoates and α-cyanoacrylates of the formula: 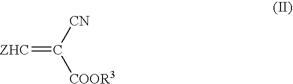
wherein Z is —CH═CH₂ and R³ is as defined above. The monomers of formula (II) wherein R³ is an alkyl group of 1-10 carbon atoms, i.e., the 2-cyanopenta-2,4-dienoic acid esters, can be prepared by reacting an appropriate 2-cyanoacetate with acrolein in the presence of a catalyst such as zinc chloride. This method of preparing 2-cyanopenta-2,4-dienoic acid esters is disclosed, for example, in U.S. Pat. No. 3,554,990, which is hereby incorporated in its entirety by reference.

Preferred α-cyanoacrylate monomers used, alone or in combination, are alkyl α-cyanoacrylates including octyl cyanoacrylate, such as 2-octyl cyanoacrylate; dodecyl cyanoacrylate; 2-ethylhexyl cyanoacrylate; methoxyethyl cyanoacrylate; 2-ethoxyethyl cyanoacrylate; butyl cyanoacrylate such as n-butyl cyanoacrylate; ethyl cyanoacrylate; methyl cyanoacrylate; 3-methoxybutyl cyanoacrylate; 2-butoxyethyl cyanoacrylate; 2-isopropoxyethyl cyanoacrylate; and 1-methoxy-2-propyl cyanoacrylate. More preferred monomers are ethyl, n-butyl, and 2-octyl α-cyanoacrylate.

Other preferred cyanoacrylates include alkyl ester cyanoacrylates. Besides the process detailed above, alkyl ester cyanoacrylates can also be prepared through the Knoevenagel reaction of an alkyl cyanoacetate, or an alkyl ester cyanoacetate, with paraformaldehyde. This leads to a cyanoacrylate oligomer. Subsequent thermal cracking of the oligomer results in the formation of a cyanoacrylate monomer. After further distillation, a cyanoacrylate monomer with high purity (greater than 95.0%, preferably greater than 99.0%, and more preferably greater than 99.8%), may be obtained.

Monomers prepared with low moisture content and essentially free of impurities (e.g., surgical grade) are preferred for biomedical use. Monomers utilized for industrial purposes need not be as pure.

In some preferred embodiments, the alkyl ester cyanoacrylate monomers have the formula: 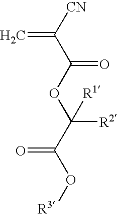
wherein R^{1′} and R^{2′} are, independently H, a straight, branched or cyclic alkyl, or are combined together in a cyclic alkyl group, and R³ is a straight, branched or cyclic alkyl group. Preferably, R¹ is H or a C₁, C₂ or C₃ alkyl group, such as methyl or ethyl; R^{2′} is H or a C₁, C₂ or C₃ alkyl group, such as methyl or ethyl; and R³ is a C₁-C₁₆ alkyl group, more preferably a C₁-C₁₀ alkyl group, such as methyl, ethyl, propyl, isopropyl, butyl, isobutyl, pentyl, hexyl, heptyl, octyl, nonyl or decyl, and even more preferably a C₂, C₃ or C₄ alkyl group.

Examples of preferred alkyl ester cyanoacrylates include, but are not limited to, butyl lactoyl cyanoacrylate (BLCA), butyl glycoloyl cyanoacrylate (BGCA), isopropyl glycoloyl cyanoacrylate (IPGCA), ethyl lactoyl cyanoacrylate (ELCA), and ethyl glycoloyl cyanoacrylate (EGCA) and combinations thereof. BLCA may be represented by the formula above, wherein R^{1′} is H, R^{2′} is methyl and R^{3′} is butyl. BGCA may be represented by the formula above, wherein R^{1′} is H, R² is H and R^{3′} is butyl. IPGCA may be represented by the formula above, wherein R^{1′} is H, R^{2′} is H and R^{3′} is isopropyl. ELCA may be represented by the formula above, wherein R^{1′} is H, R^{2′} is methyl and R^{3′} is ethyl. EGCA may be represented by the formula above, wherein R^{1′} is H, R^{2′} is H and R^{3′} is ethyl. Other cyanoacrylates useful in the present invention are disclosed in U.S. Pat. No. 3,995,641 to Kronenthal et al., the entire disclosure of which is hereby incorporated by reference.

Alternatively, or in addition, alkyl ether cyanoacrylate monomers may be used. Alkyl ethyl cyanoacrylates have the general formula: 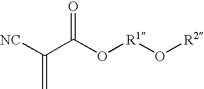
wherein R^{1″} is a straight, branched or cyclic alkyl, and R^{2″} is a straight, branched or cyclic alkyl group. Preferably, R^{1″} is a C₁, C₂ or C₃ alkyl group, such as methyl or ethyl; and R^{2″} is a C₁-C₁₋₆ alkyl group, more preferably a C₁-C₁₀ alkyl group, such as methyl, ethyl, propyl, isopropyl, butyl, isobutyl, pentyl, hexyl, heptyl, octyl, nonyl or decyl, and even more preferably a C₂, C₃ or C₄ alkyl group.

Examples of preferred alkyl ether cyanoacrylates include, but are not limited to, isopropyoxy ethyl cyanoacrylate (IPECA) and methoxy butyl cyanoacrylate (MBCA) and combinations thereof. IPECA may be represented by the formula above, wherein R^{1″} is ethylene and R^{2″} is isopropyl. MBCA may be represented by the formula above, wherein R^{1″} is n-butylene and R^{2″} is methyl.

Alkyl ester cyanoacrylates and alkyl ether cyanoacrylates are particularly useful for medical applications because of their absorbability by living tissue and associated fluids. Preferably, 100% of the polymerized and applied cyanoacrylate when using these types of cyanoacrylate monomers may be absorbed in a period of less than 3 years, preferably approximately 2-24 months, more preferably 3-18 months, and most preferably 6-12 months after application of the adhesive to living tissue. The absorption time may vary depending on the particular uses and tissues involved. Thus, for example longer absorption time may be desired where the adhesive composition is applied to hard tissues, such as bone, but a faster absorption time may be desired where the adhesive composition is applied to softer tissues.

The selection of monomer will affect the absorption rate of the resultant polymer, as well as the polymerization rate of the monomer. Two or more different monomers that have varied absorption and/or polymerization rates may be used in combination to give a greater degree of control over the absorption rate of the resultant polymer, as well as the polymerization rate of the monomer.

According to some embodiments, the adhesive composition comprises a mixture of monomer species with varying absorption rates. Where two monomer species having different absorption rates are used, it is preferred that the absorption rates be sufficiently different that a mixture of the two monomers can yield a third absorption rate that is effectively different from the absorption rates of the two monomers individually. Compositions according to these embodiments are described, for example, in U.S. patent application Ser. No. 09/919,877, filed Aug. 2, 2001, published as U.S. Patent Publication No. 2002/0037310 on Mar. 28, 2002, and U.S. Pat. No. 6,620,846, both incorporated herein by reference in their entireties.

For example, suitable compositions according to preferred embodiments can be prepared by mixing suitable quantities of 2-octyl alpha-cyanoacrylate with one of butyl lactoyl cyanoacrylate (BLCA), butyl glycoloyl cyanoacrylate (BGCA), isopropyl glycoloyl cyanoacrylate (IPGCA), ethyl lactoyl cyanoacrylate (ELCA), and ethyl glycoloyl cyanoacrylate (EGCA). Preferably, such mixtures range from ratios of about 90:10 to about 10:90 by weight, preferably about 75:25 to about 25:75 by weight such as from about 60:40 to about 40:60 by weight.

Some alkyl ester cyanoacrylate monomers may react slowly due to bulky alkyl groups, apparently limiting their applicability as surgical adhesives. By themselves, some alkyl ester cyanoacrylates cure in several hours, or in some cases do not fully cure at all. To overcome problems associated with slow polymerization of the monomers, a compatible agent which initiates or accelerates polymerization of the alkyl ester cyanoacrylate monomer, may be used with the monomer composition. Alkyl ester cyanoacrylates stimulated to cure by a suitable initiator or to cure more rapidly by an accelerator may be made to cure in as short as a few seconds to a few minutes. The cure rate may be closely controlled by selection of an amount or concentration of initiator or accelerator added to the cyanoacrylate and may thus be readily controlled by one skilled in the art in light of the present disclosure. A suitable initiator provides a consistent controllable complete polymerization of the monomer so that the polymerization of the monomer can be made to occur in the time desired for the particular application. Quaternary ammonium salts are particularly desirable as initiators with alkyl ester cyanoacrylate monomers for such reasons.

The initiator or accelerator may be in the form of a solid, such as a powder or a solid film, or in the form of a liquid, such as a viscous or paste-like material. The initiator or accelerator may also include a variety of additives, such as surfactants or emulsifiers. Preferably, the initiator or accelerator is soluble in the monomer composition, and/or comprises or is accompanied by at least one surfactant which, in embodiments, helps the initiator or accelerator co-elute with the monomer composition. In embodiments, the surfactant may help disperse the initiator or accelerator in the monomer composition.

An initiator, by way of example, may be applied to tissue before the monomer composition, or may be applied directly to the monomer composition once the monomer composition is applied to tissue. In embodiments, the initiator or accelerator may be combined with the monomer composition just prior to applying the composition to tissue.

The selection of an initiator or accelerator may additionally affect the rate at which the polymerized monomer is absorbed by living tissue. Therefore, the most suitable initiators or accelerators are those that initiate or accelerate polymerization of the monomer at a rate suitable for medical applications while providing a polymer that is substantially absorbed in less than three years.

For purposes herein, the phrase “suitable for medical application(s)” means that the initiator or accelerator initiates or accelerates polymerization of the monomer in less than 5 minutes or less than 3 minutes, preferably in less than 2.5 minutes, more preferably in less than 1 minute, and often in less than 45 seconds. Of course, the desired polymerization time can vary for different compositions and/or uses. Preferably, where absorbability is desired, a suitable initiator or accelerator and a suitable monomer are selected to provide a polymer that is substantially absorbed by a living organism in 2-24 months, such as 3-18 months or 6-12 months after application of the adhesive to living tissue.

Suitable initiators are known in the art and are described, for example, in U.S. Pat. Nos. 5,928,611 and 6,620,846, both incorporated herein by reference in their entireties and U.S. Patent Application No. 2002/0037310, also incorporated herein by reference in its entirety. Quaternary ammonium salts useful as polymerization initiators are particularly suitable. By way of example, quaternary ammonium salts such as domiphen bromide, butyrylcholine chloride, benzalkonium bromide, acetyl choline chloride, among others, may be used.

Benzalkonium halides, such as benzalkonium chloride, are particularly preferred in embodiments. When used, the benzalkonium halide can be benzalkonium halide in its unpurified state, which comprises a mixture of varying chain-length compounds, or it can be any suitable purified compound including those having a chain length of from about 12 to about 18 carbon atoms, including but not limited to C₁₂, C₁₃, C₁₄, C₁₅, C₁₆, C₁₇, and C₁₈ compounds.

Other initiators or accelerators may also be selected by one of ordinary skill in the art without undue experimentation. Such suitable initiators or accelerators may include, but are not limited to, detergent compositions; surfactants: e.g., nonionic surfactants such as polysorbate 20 (e.g., Tween 20™ from ICI Americas), polysorbate 80 (e.g., Tween 80™ from ICI Americas) and poloxamers, cationic surfactants such as tetrabutylammonium bromide, anionic surfactants such as sodium tetradecyl sulfate, and amphoteric or zwitterionic surfactants such as dodecyidimethyl(3-sulfopropyl)ammonium hydroxide, inner salt; amines, imines and amides, such as imidazole, arginine and povidine; phosphines, phosphites and phosphonium salts, such as triphenylphosphine and triethyl phosphite; alcohols such as ethylene glycol, methyl gallate; tannins; inorganic bases and salts, such as sodium bisulfite, calcium sulfate and sodium silicate; sulfur compounds such as thiourea and polysulfides; polymeric cyclic ethers such as monensin, nonactin, crown ethers, calixarenes and polymeric-epoxides; cyclic and acyclic carbonates, such as diethyl carbonate; phase transfer catalysts such as Aliquat 336; organometallics such as cobalt naphthenate and manganese acetylacetonate; and radical initiators or accelerators and radicals, such as di-t-butyl peroxide and azobisisobutyronitrile.

In embodiments, mixtures of two or more, such as three, four, or more, initiators or accelerators can be used. A combination of multiple initiators or accelerators may be beneficial, for example, to tailor the initiator of the polymerizable monomer species. For example, where a blend of monomers is used, a blend of initiators may provide superior results to a single initiator. For example, the blend of initiators can provide one initiator that preferentially initiates one monomer, and a second initiator that preferentially initiates the other monomer, or can provide initiation rates to help ensure that both monomer species are initiated at equivalent, or desired non-equivalent, rates. In this manner, a blend of initiators can help minimize the amount of initiator necessary. Furthermore, a blend of initiators may enhance the polymerization reaction kinetics.

In embodiments, any suitable applicator may be used to apply the adhesive composition to a substrate. For example, the applicator may include an applicator body, which is formed generally in the shape of a tube having a closed end, an open end, and a hollow interior lumen, which holds a crushable or frangible ampoule. The applicator and its related packaging may be designed as a single-use applicator or as a multi-use applicator. Suitable multi-use applicators are disclosed, for example, in U.S. Pat. No. 6,802,416 issued Oct. 12, 2004, the entire disclosure of which is incorporated herein by reference.

In embodiments of the invention, the applicator may comprise elements other than an applicator body and an ampoule. For example, an applicator tip may be provided on the open end of the applicator. The applicator tip material may be porous, absorbent, or adsorbent in nature to enhance and facilitate application of the composition within the ampoule. Suitable designs for applicators and applicator tips that may be used according to the present invention are disclosed in, for example, U.S. Pat. Nos. 5,928,611, 6,428,233, 6,425,704, 6,455,064, and 6,372,313, the entire disclosures of which are incorporated herein by reference.

In embodiments of the present invention, an applicator may contain the initiator or accelerator on a surface portion of the applicator or applicator tip, or on the entire surface of the applicator tip, including the interior and the exterior of the tip. When the initiator or accelerator is contained in or on an applicator tip, the initiator or accelerator may be applied to the surface of the applicator tip or may be impregnated or incorporated into the matrix or internal portions of the applicator tip, depending on the use. Additionally, the initiator or accelerator may be incorporated into the applicator tip, for example, during the fabrication of the tip.

In other embodiments, an initiator may be coated on an interior surface of the applicator body and/or on an exterior surface of an ampoule or other container disposed within the applicator body, may be placed in the applicator body in the form of a second frangible vial or ampoule and/or may be otherwise contained within the applicator body, so long as a non-contacting relationship between the polymerizable monomer composition and the initiator is maintained until use of the adhesive.

Other optional components may be present in the polymerizable cyanoacrylate compositions including thickeners, plasticizers, colorants, preservatives, heat dissipating agents, additional stabilizing agents and the like. Typically, these components will be used in amount of 0 to 25, more preferably 0 to 10, for example, 0 to 5 weight %, based on a total weight of the composition.

Preservatives useful in compositions of this invention may be anti-microbial agents. In embodiments, a preservative may be selected from among preservatives including, but not limited to, parabens and cresols. For example, suitable parabens include, but are not limited to, alkyl parabens and salts thereof, such as methylparaben, methylparaben sodium, ethylparaben, propylparaben, propylparaben sodium, butylparaben, and the like. Suitable cresols include, but are not limited to, cresol, chlorocresol, and the like. The preservative may also be selected from other known agents including, but not limited to, hydroquinone, pyrocatechol, resorcinol, 4-n-hexyl resorcinol, captan (i.e., 3a,4,7,7a-tetrahydro-2-((trichloromethyl)thio)-1H-isoindole-1,3(2H)-dione), benzoic acid, benzyl alcohol, chlorobutanol, dehydroacetic acid, o-phenylphenol, phenol, phenylethyl alcohol, potassium benzoate, potassium sorbate, sodium benzoate, sodium dehydroacetate, sodium propionate, sorbic acid, thimerosal, thymol, phenylmercuric compounds such as phenylmercuric borate, phenylmercuric nitrate and phenylmercuric acetate, formaldehyde, and formaldehyde generators such as the preservatives Germall II® and Germall 115® (imidazolidinyl urea, available from Sutton Laboratories, Charthan, N.J.). Other suitable preservatives are disclosed in U.S. Pat. No. 6,579,469, the entire disclosure of which is hereby incorporated by reference. In embodiments, mixtures of two or more preservatives may also be used.

Monomer compositions of the invention may also include a heat dissipating agent. Heat dissipating agents include liquids or solids that may be soluble or insoluble in the monomer. The liquids may be volatile and may evaporate during polymerization, thereby releasing heat from the composition. Suitable heat dissipating agents may be found in U.S. Pat. No. 6,010,714 to Leung et al., the entire disclosure of which is incorporated herein.

The composition may also optionally include at least one plasticizing agent that imparts flexibility to the polymer formed from the monomer. The plasticizing agent preferably contains little or no moisture and should not significantly affect the stability or polymerization of the monomer. Such plasticizers are useful in polymerized compositions to be used for closure or covering of wounds, incisions, abrasions, sores or other applications where flexibility of the adhesive is desirable. Some thickeners, such as poly-2-ethylhexylcyanoacrylate, may also impart flexibility to the polymer.

Examples of suitable plasticizers include acetyl tributyl citrate, dimethyl sebacate, dibutyl sebacate, triethyl phosphate, tri(2-ethylhexyl)phosphate, tri(p-cresyl) phosphate, glyceryl triacetate, glyceryl tributyrate, diethyl sebacate, dioctyl adipate, isopropyl myristate, butyl stearate, lauric acid, trioctyl trimellitate, dioctyl glutarate, polydimethylsiloxane, and mixtures thereof. Preferred plasticizers are tributyl citrate and acetyl tributyl citrate. In embodiments, suitable plasticizers include polymeric plasticizers, such as polyethylene glycol (PEG) esters and capped PEG esters or ethers, polyester glutarates and polyester adipates.

The addition of plasticizing agents in amounts ranging from 0.5 wt. % to 25 wt. %, or from 1 wt. % to 20 wt. %, or from 3 wt. % to 15 wt. % or from 5 wt. % to 7 wt. % provides increased elongation and toughness of the polymerized monomer over polymerized monomers not having plasticizing agents.

The composition may also include at least one thickening agent. Suitable thickening agents include, for example, polycyanoacrylates, polylactic acid, polyglycolic acid, lactic-glycolic acid copolymers, polycaprolactone, lactic acid-caprolactone copolymers, poly-3-hydroxybutyric acid, polyorthoesters, polyalkyl acrylates, copolymers of alkylacrylate and vinyl acetate, polyalkyl methacrylates, and copolymers of alkyl methacrylates and butadiene.

The composition may also optionally include at least one thixotropic agent. Suitable thixotropic agents are known to the skilled artisan and include, but are not limited to, silica gels such as those treated with a silyl isocyanate. Examples of suitable thixotropic agents are disclosed in, for example, U.S. Pat. No. 4,720,513, the disclosure of which is hereby incorporated in its entirety.

The composition may also optionally include at least one natural or synthetic rubber to impart impact resistance, which is preferable especially for industrial compositions of the present invention. Suitable rubbers are known to the skilled artisan. Such rubbers include, but are not limited to, dienes, styrenes, acrylonitriles, and mixtures thereof. Examples of suitable rubbers are disclosed in, for example, U.S. Pat. Nos. 4,313,865 and 4,560,723, the disclosures of which are hereby incorporated in their entireties.

Medical compositions of the present invention may also include at least one biocompatible agent effective to reduce active formaldehyde concentration levels produced during in vivo biodegradation of the polymer (also referred to herein as “formaldehyde concentration reducing agents”). Preferably, this component is a formaldehyde scavenger compound. Examples of useful formaldehyde scavenger compounds include sulfites; bisulfites; and mixtures of sulfites and bisulfites, among others. Useful additional examples of formaldehyde scavenger compounds and methods for their implementation may be found U.S. Pat. Nos. 5,328,687, 5,514,371, 5,514,372, 5,575,997, 5,582,834 and 5,624,669, all to Leung et al., which are hereby incorporated herein by reference in their entireties. A preferred formaldehyde scavenger is sodium bisulfite.

In preferred embodiments, the formaldehyde concentration reducing agent is added in an effective amount to the cyanoacrylate. The “effective amount” is that amount sufficient to reduce the amount of formaldehyde generated during subsequent in vivo biodegradation of the polymerized cyanoacrylate. This amount will depend on the type of active formaldehyde concentration reducing agent, and can be readily determined without undue experimentation by those skilled in the art.

The formaldehyde concentration reducing agent may be used in either free form or in microencapsulated form. When microencapsulated, the formaldehyde concentration reducing agent is released from the microcapsule continuously over a period of time during the in vivo biodegradation of the cyanoacrylate polymer.

The microencapsulated form of the formaldehyde concentration reducing agent is preferred because this embodiment prevents or substantially reduces polymerization of the cyanoacrylate monomer by the formaldehyde concentration reducing agent, which increases shelf-life and facilitates handling of the monomer composition during use. Microencapsulation techniques are disclosed in U.S. Pat. No. 6,512,023, incorporated herein by reference in its entirety.

By way of example, in one embodiment, the cyanoacrylate adhesive composition comprises about 75% 2-octylcyanoacrylate, about 25% butyl lactoylcyanoacrylate, less than about 70 ppm hydroquinone, about 1600 ppm BHA, about 110 ppm p-methoxyphenol, about 5.0 ppm sulfuric acid, about 15.0 ppm sulfur dioxide, and about 103.0 ppm acetic acid. The cyanoacrylate adhesive composition may be used, for example, with about 0.0195% of a quaternary ammonium salt as an initiator.

Having generally described this invention, a further understanding can be obtained by reference to certain specific examples which are provided herein for purposes of illustration only and are not intended to be limiting unless otherwise specified.

### EXAMPLES

### Example 1

In order to determine mutagenic activity for cyanoacrylate compositions containing hydroquinone, a mouse lymphoma screening study was conducted according to methods known in the art. The assay protocol used was 431ICH1 edition 3 (L5178Y TK^{±}) and was conducted by Covance, Inc. The amount of radical stabilizer in each of the cyanoacrylate compositions was varied. The selective agent was 3.0 μg/ml 5-trifluorothymidine (TFT). The results of the screening study are shown below in Table 1. As illustrated in the table, only the cyanoacrylate composition with about 1200 ppm hydroquinone showed mutagenic activity (defined as 124.1×10E-6 units). The cyanoacrylate composition with less than 1200 ppm hydroquinone did not meet the minimum requirement for mutagenic activity but the exact amount of hydroquinone in this sample was uncertain due to the composition having been pre-extracted. The cyanoacrylate compositions containing less than 70 ppm hydroquinone and either 3000 ppm or 1000 ppm of BHA had mutagenic activity below the minimum mutagenic criterion, similar to the control (see column showing mutant frequency results).

TABLE 1
MUTATION ASSAY WITHOUT ACTIVATION

| | | | | | | | | Mutant |
|---|---|---|---|---|---|---|---|---|
| | Daily Cell Counts | | | | | | Relative | Frequency |
| Test | (Cell/ML, 10E5 units) | | Cumulative | Total Mutant | Total Viable | Cloning | Total Growth | (10E−6 |
| Condition | Day 1 | Day 2 | RSG^{a} | Colonies | Colonies | Efficiency^{b} | (%)^{c} | Units)^{d} |
| Vehicle | 11.8 | 11.2 | 14.7 | 170 | 549 | 91.5 | 100.0 | 62.0 |
| Control^{e} | | | | | | | | |
| | | | Relative to | | | Relative to | | |
| | | | Vehicle | | | Vehicle | | |
| | | | Control (%) | | | Control (%) | | |
| ≈1200 ppm HQ | 1.6 | 6.5^{g} | 14.8 | 419 | 421 | 76.7 | 11.3 | 199.0^{f} |
| <1200 ppm HQ | 8.8 | 10.6 | 70.6 | 193 | 567 | 103.4 | 73.0 | 68.1 |
| <70 ppm HQ + | 11.0 | 9.9 | 82.4 | 205 | 553 | 100.8 | 83.1 | 74.2 |
| 3000 ppm BHA | | | | | | | | |
| <70 ppm HQ + | 9.8 | 8.6 | 63.8 | 249 | 576 | 105.0 | 66.9 | 86.4 |
| 1000 ppm BHA | | | | | | | | |
| HQ in saline | 0.5 | 0.9^{g} | 2.0 | h | h | h | h | h |

^{a}RSG = (Day 1 Count/3) * (Day 2 Count)/3 (or Day 1 Count if not subcultured)
^{b}Cloning Efficiency = Total Viable Colony Count/Number of Cells Seeded * 100
^{c}Relative Total Growth = (Relative Suspension Growth * Relative Cloning Efficiency)/100
^{d}Mutant Frequency = (Total Mutant Colonies/Total Viable Colonies) * 2 × 10E−4
^{e}Vehicle Control = 10% Saline
^{f}Mutagenic. Exceeds minimum criterion of 124.1 × 10E−6
^{g}Not subcultured
h Insufficient data for calculations = not cloned, extreme toxicity

### Example 2

The stability of cyanoacrylate compositions with differing amounts of hydroquinone was determined. The formulations tested are shown in Table 2.

TABLE 2

| Component | CAS | Function | Formulation A | Formulation B |
|---|---|---|---|---|
| 2-Octylcyanoacrylate | 133978 | adhesive | 74.86% | 74.86% |
| Butyl Lactoylcyanoacrylate | NA | adhesive | 24.95% | 24.95% |
| Hydroquinone | 123-31-9 | radical | ≈1202 ppm | <70 ppm |
| Butylated Hydroxyanisole | 25013-16-5 | radical | 2000 ppm | 1600 ppm |
| p-Methoxyphenol | 150-76-5 | radical | ≈110 ppm | ≈112 ppm |
| Sulfuric Acid | 7664-93-9 | anionic | ≈18.0 ppm | ≈20.0 ppm |
| Sulfur Dioxide | 7446-09-5 | anionic | ≈12.0 ppm | ≈11.0 ppm |
| Acetic Acid | 64-19-7 | anionic | ≈108.0 ppm | ≈106.0 ppm |
| Total of liquid component | | | 100% | 100% |

Viscosity Measurement Method

The cyanoacrylate adhesive compositions above were tested for stability according to viscosity studies using a Brookfield Cone/Plate Viscometer according to the following method:

A Brookfield Cone and Plate Viscometer Model DV II+ with spindle CP-40 was used to determine the viscosity of the test sample. The sample cup of the viscometer was connected to a recirculating water bath capable of maintaining a temperature of 25±1° C. A calibration procedure was performed to separate the cone and plate a distance of 0.0005 inches (0.013 mm). A set of viscosity standards, general-purpose silicone fluids of known viscosity values obtained from Brookfield Engineering Laboratories, Inc., were used to calibrate the instrument. Generally standards of 5 and 50 centipoise were used. Once the instrument was calibrated, samples were tested.

The test sample was dispensed into the sample cup (0.6 mL/determination) and spread evenly. The cup was attached to the spindle creating the cone (spindle) and plate (cup) geometry. The spindle was rotated at a set speed (rpm) to achieve a display reading within the linear range of the instrument: 40-90% (torque). The spindle was rotated for a minimum of 20 revolutions before taking a reading. For example, if the spindle is set to 60 rpm, 20 revolutions will take 20 seconds (20 revolutions X 60 revolutions/60 seconds=20 seconds). The display reading and speed was recorded.

The viscosity was calculated as a proportion compared to the most similar standard. For example, two standards were run: 4.8 cPs at 30 rpm had a display of 45.3% and 48.6 cPs at 3 rpm had a display of 44.5%. The factor for 30 rpm is 4.8/45.3=0.1060 and for 3 rpm is 48.6/44.5=1.0921. A sample run at 30 rpm with a display of 67.6% would have a viscosity of 7.2 cPs (67.6×0.1060=7.2 cPs). Other speeds have factors constructed from the nearest standard. For example, the factor for 20 rpm would be proportional to that of 30 rpm, the nearest standard. The factor would be 0.1590 ((30×0.1060)/20=0.1590). A sample tested at 20 rpm with a display of 86.5% would have a viscosity of 13.8 cPs (86.5×0.1590=13.8 cPs). Samples were measured in triplicate and the average was calculated.

The procedure for the preparation and testing was as follows. 250 g (or 25%) of BLCA and 750 g of 2-OCA was placed in a large high-density polyethylene container and mixed well. During the manufacture of the 2-OCA, the hydroquinone and components p-methoxyphenol, sulfuric acid, sulfur dioxide, and acetic acid were included into the formulation. The amounts of components p-methoxyphenol, sulfuric acid, sulfur dioxide, and acetic acid were substantially similar as shown in Table 2 for both formulation A and formulation B. The hydroquinone was included according to the manufacturing tolerance of 0-70 ppm.

Approximately 1600 ppm (formulation B) or 2000 ppm (formulation A) of BHA was added to the blend. The exact amount of BHA to be added was dependent on the total amount of the blend and the amount of BHA already present in the 2-OCA portion of the blend. At least 5 g of the blend was then tested for pre-sterilization viscosity using a Brookfield Cone/Plate Viscometer test, as described.

At least 1680 onion skin tubes were filled and sealed with 500 μl of cyanoacrylate composition each to provide test samples. The sample compositions were then dry-heat sterilized using a dry-heat tunnel oven. The samples were allowed to cool down for at least two hours after sterilization.

The samples were stored in stability chambers under 80° C. accelerated conditions (dry heat). The test samples were tested for viscosity as described above at preset intervals of 6, 12 and 18 days. As the sample materials thicken over time, the shelf life may be decreased. Testing of any of the storage conditions was to be terminated when 40 cP was reached. The batches that were evaluated demonstrated consistency and acceptance up to 12 days at 80° C. Based on prior stability studies for cyanoacrylate adhesive compositions, exposure to 80° C. for 6, 12 and 18 days generally correlates to 1, 2 and 3 years at room conditions, respectively. Thus, it is believed that the sample cyanoacrylate adhesive compositions would be expected to be stable for at least about two years.

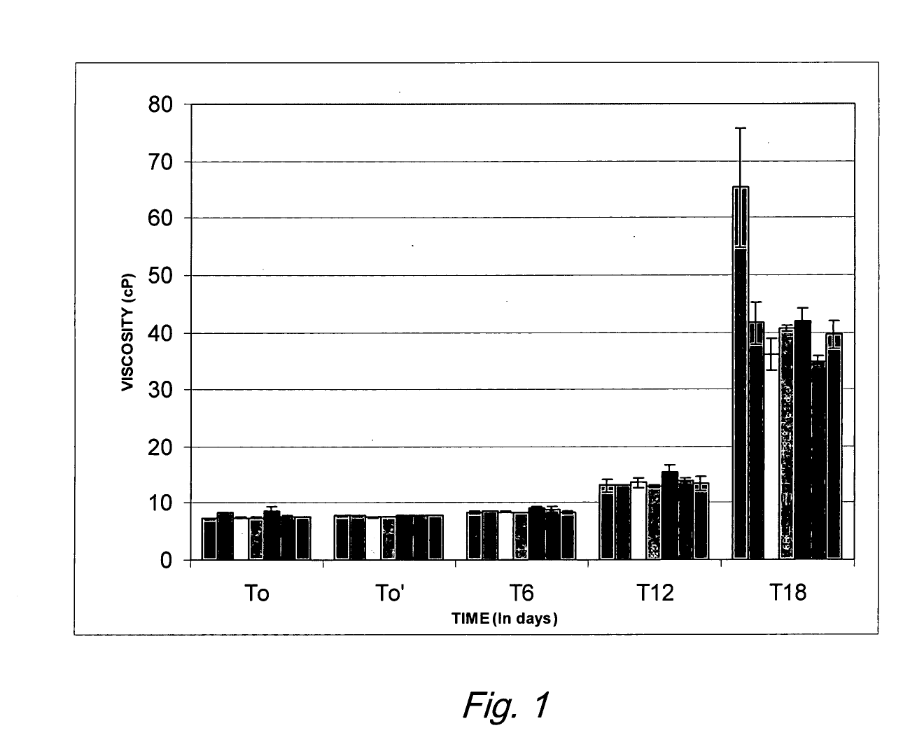

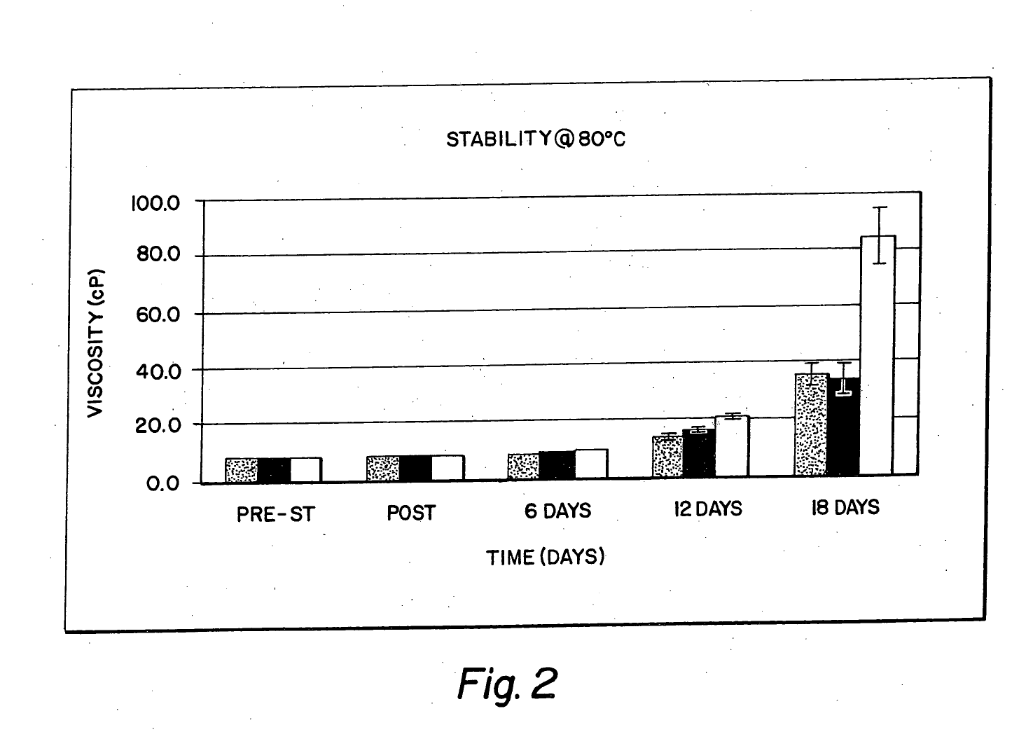

Seven batches of comparative samples (using seven different lots of cyanoacrylate samples) of the formulation of formulation A containing 1200 ppm hydroquinone were tested. FIG. 1 is a graphic illustration of the stability data obtained when samples according to formulation A were tested for viscosity in a study using 80° C. accelerated conditions. Three batches of samples (using three different lots of cyanoacrylate samples) were tested according to the formulation of formulation B as set forth in Table 2. Chromatography was conducted on the compositions, which indicated that the three batches included 53, 54, and 25 ppm, respectively, (manufacturer's range: 0-70 ppm) of hydroquinone. FIG. 2 is a graphic illustration of the stability data obtained from the viscosity testing under 80° C. accelerated conditions over time conducted on the lots of formulation B. As shown in FIGS. 1 and 2, the use of low levels of hydroquinone in formulation B provided adequate stability when compared to the higher levels used in the formulation A. However, as shown in Example 1, the hydroquinone does not exhibit mutagenicity at the levels of the samples of formulation B.

While the invention has been described with reference to preferred embodiments, the invention is not limited to the specific examples given, and other embodiments and modifications can be made by those skilled in the art without departing from the spirit and scope of the invention.

1. A stabilized adhesive composition comprising:
one or more polymerizable cyanoacrylate monomers,
a first free radical stabilizer consisting of hydroquinone in an amount of 5 to 70 ppm and a second free radical stabilizer consisting of butylated hydroxyanisole in an amount of 500 to 10,000 ppm.

2. The stabilized adhesive composition of claim 1 further comprising a third free radical stabilizer.

3. The stabilized adhesive composition of claim 2 wherein the third free radical stabilizer is p-methoxy phenol.

4. The stabilized adhesive composition of claim 1 wherein the one or more polymerizable cyanoacrylate monomers are selected from the group consisting of octyl cyanoacrylate; dodecyl cyanoacrylate; 2-ethylhexyl cyanoacrylate; methoxyethyl cyanoacrylate; 2-ethoxyethyl cyanoacrylate; butyl cyanoacrylate; ethyl cyanoacrylate; methyl cyanoacrylate; 3-methoxybutyl cyanoacrylate; 2-butoxyethyl cyanoacrylate; 2-isopropoxyethyl cyanoacrylate; 1-methoxy-2-propyl cyanoacrylate; butyl lactoyl cyanoacrylate; butyl glycoloyl cyanoacrylate; isopropyl glycoloyl cyanoacrylate; ethyl lactoyl cyanoacrylate; ethyl glycoloyl cyanoacrylate; isopropyoxy ethyl cyanoacrylate; methoxy butyl cyanoacrylate; and mixtures thereof.

5. The stabilized adhesive composition of claim 4 wherein the one or more polymerizable cyanoacrylate monomers are 2-octyl cyanoacrylate and butyl lactoyl cyanoacrylate.

6. The stabilized adhesive composition of claim 1 further comprising a vapor phase anionic stabilizer and a liquid phase anionic stabilizer.

7. The stabilized adhesive composition of claim 1 wherein the hydroquinone is in an amount of 15 to 60 ppm.

8. The stabilized adhesive composition of claim 1 wherein the hydroquinone is in an amount of 20 to 50 ppm.

9. The stabilized adhesive composition of claim 8 wherein the butylated hydroxy anisole is in an amount of 1000 to 2000 ppm.

10. A stabilized adhesive composition comprising:
one or more polymerizable cyanoacrylate monomers,
a first free radical stabilizer consisting of hydroquinone in a stabilization effective amount and a second free radical stabilizer consisting of butylated hydroxyanisole in a stabilization effective amount, wherein the ratio of the stabilization effective amount of hydroquinone to the stabilization effective amount of butylated hydroxyanisole is 1:25 to 1:75.

11. A stabilized adhesive composition comprising:
one or more polymerizable cyanoacrylate monomers,
a first free radical stabilizer consisting of hydroquinone in a stabilization effective amount,
a second free radical stabilizer consisting of butylated hydroxyanisole in a stabilization effective amount,
a first anionic stabilizer comprising a vapor phase anionic stabilizer, and
a second anionic stabilizer comprising a liquid phase anionic stabilizer,
wherein the stabilized adhesive composition exhibits a viscosity of less than 200 cp over a period of at least one year and exhibits a mutagenicity activity level less than a minimum criteria of mutant frequency of 124.1×10E-6 units in a mouse lymphoma screening test.

12. The stabilized adhesive composition of claim 11 further comprising a third anionic stabilizer.

13. The stabilized adhesive composition of claim 12 wherein the third anionic stabilizer is acetic acid.

14. The stabilized adhesive composition of claim 11 wherein the one or more polymerizable cyanoacrylate monomers are 2-octyl cyanoacrylate and butyl lactoyl cyanoacrylate.

15. A method of treating living tissue, comprising:
applying to living tissue a biocompatible adhesive composition comprising:
one or more polymerizable cyanoacrylate monomers,
a first free radical stabilizer consisting of hydroquinone in a stabilization effective amount,
a second free radical stabilizer consisting of butylated hydroxyanisole in a stabilization effective amount,
a first anionic stabilizer comprising a vapor phase anionic stabilizer, and
a second anionic stabilizer comprising a liquid phase anionic stabilizer,
wherein the ratio of the stabilization effective amount of hydroquinone to the stabilization effective amount of butylated hydroxyanisole is 1:25 to 1:75.

16. The method of claim 15 wherein the biocompatible adhesive composition is applied in conjunction with a polymerization initiator.

17. The method of claim 16 wherein the living tissue is internal living tissue.

18. The method of claim 15 wherein the one or more polymerizable cyanoacrylate monomers are 2-octyl cyanoacrylate and butyl lactoyl cyanoacrylate.

19. The method of claim 16 wherein the polymerization initiator is a quaternary ammonium salt.

20. The method of claim 15 wherein the biocompatible adhesive composition is sterilized by dry heat sterilization prior to being applied to living tissue.
